(19) United States
(12) Patent Application Publication
(10) Pub. No.: US 2015/0341631 A1
(43) Pub. Date: Nov. 26, 2015

(54) DETECTING DEVICE FOR DISPLAY APPARATUS AND DETECTING METHOD THEREOF, AND DISPLAY SYSTEM

(71) Applicant: Boe Technology Group Co., Ltd., Beijing (CN)

(72) Inventor: Yongjie LU, Beijing (CN)

(21) Appl. No.: 14/548,942

(22) Filed: Nov. 20, 2014

(30) Foreign Application Priority Data
May 26, 2014 (CN) 201410226028.7

(51) Int. Cl. H04N 17/04; G09G 3/00; H04N 9/30

(52) U.S. Cl. CPC H04N 17/045; H04N 9/30; G09G 3/006

(57) ABSTRACT

The invention provides a detecting device for display apparatus, a detecting method for display apparatus, and a display system. The detecting device for display apparatus comprises: a control unit for controlling the display apparatus to display a predetermined test content, a collecting unit for collecting an actual display content displayed on the display apparatus when the display apparatus is controlled to display the predetermined test content; a comparison unit for comparing the actual display content collected by the collecting unit with the test content to determine whether they are identical or not; and a reporting unit for reporting the comparison result from the comparison unit. The detecting device for display apparatus in the invention is especially applicable to inspect the display apparatuses provided in buses, subways, trains, buildings and elevators.

### FIELD OF THE INVENTION

The invention relates to the field of display technology, in particular, to a detecting device for display apparatus, a detecting method for display apparatus, and a display system.

### BACKGROUND OF THE INVENTION

A large amount of display apparatuses (such as liquid crystal display apparatuses) are provided in public places such as buses, subways, trains, buildings and elevators for displaying specific program, advertisement, and promotion video and the like. Since the display apparatuses are used in complex environments, failure rate is high. Furthermore, as viewers of the display apparatuses are common people, therefore, when there is wrong with the display apparatus, the viewers will not report it to the operators, resulting in that the failure cannot be found in time, and thus the display effect of the display apparatus is decreased.

In order to solve above problem, an existing method is that the operators of the display apparatus send persons for routinely inspecting the display apparatus one by one. However, the display apparatuses provided in public places are huge in number, and are dispersed in different locations, therefore, for the routine inspection, more labors are needed, thus cost is high, and more time are spent. In addition, it cannot be ensured that the failures can be found in time.

### SUMMARY OF THE INVENTION

To solve the technical problem that the failures occurring in the display apparatus cannot be found in time in the prior art, the invention provides a detecting device for display apparatus, a detecting method for display apparatus, and a display system, which can find failures in the display apparatus in time.

A solution adopted to solve above problem is a detecting device or display apparatus, comprising:
a control unit, for controlling the display apparatus to display a predetermined test content;
a collecting unit, for collecting an actual display content displayed on the display apparatus when the display apparatus is controlled to display the predetermined test content;
a comparison unit, for comparing the actual display content collected by the collecting unit with the test content to determine whether they are identical or not; and
a reporting unit, for reporting the comparison result from the comparison unit.

Preferably, the control unit controls the display apparatus to display the predetermined test content when the display apparatus is powered on.

Preferably, the test content includes monochrome pictures of primary colors of the display apparatus.

Further preferably, the collecting unit is a color sensor.

Further preferably, the color sensor is used to collect color at a corner of a display panel of the display apparatus.

Preferably, the reporting unit is a wireless transmitting unit for transmitting the comparison result from the comparison unit to a specified terminal wirelessly.

Further preferably, the wireless transmitting unit is used to transmit the comparison result from the comparison unit to a specified terminal through a 2G network.

Preferably, the reporting unit is used to report the comparison result from the comparison unit when the actual display content collected by the collecting unit is different from the test content.

A solution adopted to solve above problem is a display system, comprising:
a display apparatus; and
the above detecting device for display apparatus for detecting the display apparatus.

A solution adopted to solve above problem is a detecting method of a display apparatus, comprising:
a control unit controls the display apparatus to display a predetermined test content:
a collecting unit collects an actual display content displayed on the display apparatus when the display apparatus is controlled to display the predetermined test content;
a comparison unit compares the actual display content collected by the collecting unit with the test content to determine whether they are identical or not and
a reporting unit reports the comparison result from the comparison unit.

The detecting device for display apparatus in the invention comprises a control unit, which can control the display apparatus to display a predetermined test content, and the collecting unit may collect the actual display content at the time displayed on the display apparatus. When the display apparatus operates normally, the actual display content and the test content are identical, and in contrast, when a failure occurs in the display apparatus, the actual display content and the test content are necessarily different, therefore, whether there is a failure in the display apparatus can be determined through comparing the actual display content and the test content by the comparison unit, and if there is a failure, the reporting unit may report the failure, then the failure can be found and can be eliminated in time, and thus the display effect can be improved.

The detecting device for display apparatus in the invention is especially applicable to inspect the display apparatuses provided in public places such as buses, subways, trains, buildings and elevators.

### BRIEF DESCRIPTION OF THE DRAWINGS

FIG. 1 is a structural diagram of the detecting device for display apparatus of Embodiment 1 in the invention; and

FIG. 2 is a flowchart of the detecting method for display apparatus of Embodiment 2 in the invention.

### DETAILED DESCRIPTION OF EMBODIMENTS

In order to make a person skilled in the art understand the solution in the invention better, the invention will be further described in detail below in conjunction with drawings and embodiments.

### Embodiment 1

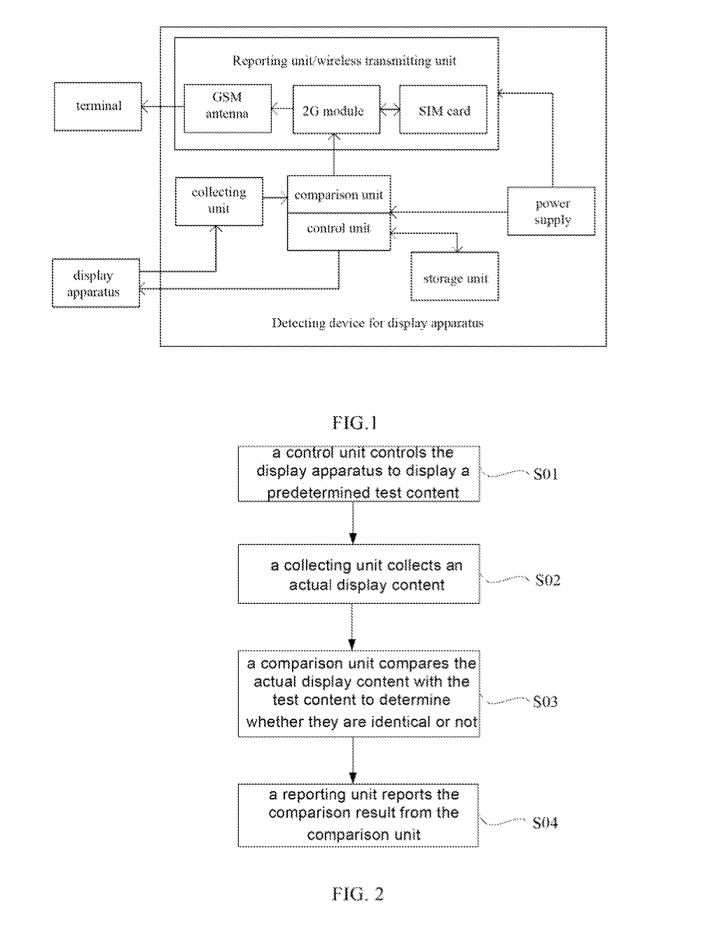

The embodiment provides a detecting device for display apparatus, as shown in FIG. 1, which comprises:
a control unit, for controlling the display apparatus to display a predetermined test content;
a collecting unit, for collecting an actual display content displayed on the display apparatus when the display apparatus is controlled to display the predetermined test content;
a comparison unit, for comparing the actual display content collected by the collecting unit with the test content to determine whether they are identical or not; and
a reporting unit, for reporting the comparison result from the comparison unit.

The detecting device for display apparatus in the invention comprises a control unit, which can control the display apparatus to display a predetermined test content, and the collecting unit may collect the actual display content at the time displayed on the display apparatus. When the display apparatus operates normally, the actual display content and the test content are identical, and in contrast, when a failure occurs in the display apparatus, the actual display content and the test content are necessarily different, therefore, whether there is a failure in the display apparatus can be determined through comparing the actual display content and the test content by the comparison unit, and if there is a failure, the reporting unit may report the failure, then the failure can be found and can be eliminated in time, and thus the display effect can be improved.

The detecting device for display apparatus in the invention can be used to detect the operation state of the display apparatus, the detected display apparatus may be a liquid crystal display apparatus, an Organic Light-Emitting Diode (OLED) display apparatus and any other known display apparatus.

Preferably, the above display apparatus includes the display apparatus provided in public places such as buses, subways, trains, buildings and elevators

As described above, it is hard to find the failures of the display apparatuses when they are provided in public places, therefore, the detecting device for display apparatus of the embodiment is preferably applicable to detect these display apparatuses. However, it should be understood that it is also feasible to use the detecting device for display apparatus in the embodiment to detect the household display apparatus.

The above control unit is used to control the display apparatus to display the determined test content, and it may specifically be an ARM chip (such as LPC1754 chip). The ARM chip is preferable, as it is simple and of low cost, and its function can meet the requirements. Of course, it should be understood that the example of the control unit is not limited thereto, and it may also be a Programmable logic controller (PLC), a microprocessor and the like.

Meanwhile, the above ARM chip (control unit) may control the reporting unit in addition to control the display apparatus to display the display test content, and may perform the above comparison function (that is, may function as the comparison unit). That is to say, the various units in the embodiment may be separated hardwares, or may be integrated.

Preferably, the control unit controls the display apparatus to display the predetermined test content when the display apparatus is powered on; and the test content includes monochrome pictures of primary colors of the display apparatus.

The display apparatus typically comprises various “sub-pixels” of different colors, through combination of the “sub-pixels” of different colors, the display apparatus may display any desired color, and the types of colors of the sub-pixels in the display apparatus are called “primary colors” of the display apparatus. For example, for a display apparatus of RGB mode (red-green-blue mode), its primary colors include red, green and blue, and thus when it is powered on, the control unit controls the driving board card of the display apparatus so that the display apparatus may display monochrome pictures of red, green and blue of three primary colors sequentially (for example, each picture is displayed for one second). Of course, for a display apparatus of RGBY mode (red-green-blue-yellow mode) or RGBW mode (red-green-blue-white mode) and the like, a yellow picture and a white picture may be added to the test content.

The reason for displaying the test content when the display apparatus is powered on is in that the test can be performed in a short time after the display apparatus is powered on and the possible failure may be found in time, and as the display apparatus displays normal content most of the time, there is a little influence on normal viewing.

Of course, it is feasible to display the test content in other manners, for example, the test content may be displayed once every a predetermined time interval, or displayed upon a specific order is received.

The reason for adopting the pictures of primary colors of the display apparatus as the test content is in that if the display apparatus can normally display the pictures of primary colors, probability of occurring of failures when displaying other pictures is small, and thus the display apparatus is substantially recognized to be normal.

It should be understood that, it is also feasible to use a preset picture as the test content.

The above collecting unit is used to collect the actual content displayed on the display apparatus, that is, to determine what picture the display apparatus is actually displaying.

Preferably, the collecting unit is a color sensor, and further preferably, the color sensor is used to collect color at a corner of a display panel of the display apparatus.

Obviously, for a monochrome picture, when its color is determined, its display content is determined. Therefore, when the test content is a picture of a primary color, the color sensor may be used as the collecting unit so as to reduce the cost and simplify the structure. Specifically, a TCS3472 chip from TAOS company of USA can be used as the color sensor, which adopts Small Outline Integrated Circuit Package (SOIC) with 8 pins, and which is 3 mm×4 mm in size, in the chip, 64 photodiodes are integrated therein, and these photodiodes are classified into four types: 16 photodiodes therein are provided with red color filters (only red light can be transmitted therethrough), 16 photodiodes therein are provided with green color filters (only green light can be transmitted therethrough), 16 photodiodes therein are provided with blue color filters (only blue light can be transmitted therethrough), and 16 photodiodes therein are provided with no color filters all lights can be transmitted therethrough). These photodiodes are alternately arranged inside the chip so as to decrease the non-uniformity of incident light to a largest extent; meanwhile, the photodiodes with the same color filters are connected in parallel so as to eliminate the position error of color. In operation, desired color filters may be selected to be turned on dynamically through two programmable pins. When the color filters of a certain color are turned on, signals generated by the corresponding photodiodes represent the light intensity of the certain color.

Further preferably, the color sensor is used to collect color at a corner of a display panel of the display apparatus. For example, the color sensor may be fixed or adhered to a corner of a display panel of the display apparatus.

The reason for above is in that providing the color sensor at the corner of the display panel results in little blocking of the sight of viewer and thus there is a little influence on display. Meanwhile, it is found from practice that, most of the display apparatuses with failures display white or black pictures as a whole, and a display wherein a part thereof is failed and other parts are normal is rarely. Therefore, in general, the display at any position of the display panel may represent the overall display of the whole display apparatus, and thus it is unnecessary to collect the display content of the whole display panel.

Of course, the above collecting unit may also be of other forms, for example, it may be a camera collecting the picture of the whole display panel of the display apparatus.

As described above, the comparison unit may be integrated with the control unit, and then compare the collected actual display content with the predetermined test content (for example, compare the collected color with the red, green or blue) to judge whether they are identical, and thus whether the display apparatus operates normally can be determined. Specifically, the color sensor converts a current signal representing light intensity of the identified color (generated by the photodiodes) into a voltage signal and transmits it to the ARM chip, and the ARM chip analyses the voltage signal through a computing unit thereinside so as to judge whether the color is identical to a predetermined output color.

The above reporting unit is used to report the comparison result from the comparison unit, that is, through a certain means, a predetermined person can be informed of the detection result.

Preferably, the reporting unit is a wireless transmitting unit for transmitting the comparison result from the comparison unit to a specified terminal wirelessly.

That is to say, the reporting unit preferably is a wireless transmitting unit so that the comparison result can be transmitted wirelessly (for example, to a server of the display apparatus operator, so that the display apparatus operator can learn which display apparatuses are in failure in time). The reason for adopting wireless transmitting is in that, as described above, the detecting device for display apparatus is mainly used to detect the display apparatus provided in public places, such as buses, subways, trains, buildings and elevators, and these display apparatuses are large in number, distributed everywhere, and many display apparatuses are always moving, therefore, it is hard to use other means to report.

Further preferably, the wireless transmitting unit is used to transmit the comparison result from the comparison unit to a specified terminal through a 2G network, that is, the wireless transmitting unit may transmit the comparison result through an existing 2G communication network. Accordingly, the wireless transmitting unit may comprise a 2G module, a SIM card, a GSM antenna and the like. Specifically, the 2G module may be an MG2639_V3 chip from Zhongxing Telecommunication Equipment Corporation (ZTE), wherein the ARM chip outputs its comparison result to the 2G module, and the 2G module transmits the comparison result to the 2G network through the GSM antenna, and the communication expense may be stored in the SIM card. The 2G network is preferable due to its wide coverage, mature technology, low cost and its capabilities which can fully meet the requirements.

Of course, the reporting unit is not limited hereto, and the reporting unit may also report the comparison result through other means, for example, through other wireless communication means such as 3G, 4G, infrared communication, RF and the like. Alternatively, the reporting unit may also report the comparison result through a wire link for the display apparatuses provided at relatively fixed places in the elevators and the buildings.

Preferably, the reporting unit is used to report the comparison result from the comparison unit when the actual display content collected by the collecting unit is different from the test content.

Obviously, when the display apparatus operates normally, it is unnecessary to always report the comparison result, the comparison result can be reported only when there is a failure in the display apparatus (that is, the comparison result shows a difference) as to handle the failure in time after receiving the report.

Of course, the reporting unit may also report in other manners, for example, report after every detection.

The detecting device for display apparatus may also comprise some other components, such as a power supply for powering other units, a memory unit connected to the control unit (for example, an Electrically-Erasable Programmable Read-Only Memory for storing the equipment number and SIM card) and the like, which will not described herein.

The embodiment also provides a display system, which comprises:
the above display apparatus; and
the above detecting device for display apparatus for detecting the display apparatus.

Obviously, the display system is preferably used in public places such as buses, subways, trains, buildings and elevators.

### Embodiment 2

The embodiment provides a detecting method of a display apparatus, as shown in FIG. 2, which comprises:

S01, a control unit controls the display apparatus to display a predetermined test content;

S02, a collecting unit collects an actual display content displayed on the display apparatus when the display apparatus is controlled to display the predetermined test content;

S03, a comparison unit compares the actual display content collected by the collecting unit with the test content to determine whether they are identical or not; and

S04, a reporting unit reports the comparison result from the comparison unit.

It should be understood that the embodiments above are just exemplary embodiments of the present invention to describe the principle of the present invention, and the present invention is not limited thereto. Any person skilled in the art can make various changes and substitutions without departing from the spirit and substance of the present invention, which should be considered to be within the protection scope of the present invention.

1. A detecting device for display apparatus, comprising:
a control unit, for controlling the display apparatus to display a predetermined test content;
a collecting unit, for collecting an actual display content displayed on the display apparatus when the display apparatus is controlled to display the predetermined test content;
a comparison unit, for comparing the actual display content collected by the collecting unit with the test content to determine whether they are identical or not; and
a reporting unit, for reporting the comparison result from the comparison unit.

2. The detecting device for display apparatus of claim 1, wherein
the control unit controls the display apparatus to display the predetermined test content when the display apparatus is powered on.

3. The detecting device for display apparatus of claim 1, wherein
the test content includes monochrome pictures of primary colors of the display apparatus.

4. The detecting device for display apparatus of claim 3, wherein
the collecting unit is a color sensor.

5. The detecting device for display apparatus of claim 4, wherein
the color sensor is used to collect color at a corner of a display panel of the display apparatus.

6. The detecting device for display apparatus of claim 1, wherein
the reporting unit is a wireless transmitting unit for transmitting the comparison result from the comparison unit to a specified terminal wirelessly.

7. The detecting device for display apparatus of claim 6, wherein
the wireless transmitting unit is used to transmit the comparison result from the comparison unit to a specified terminal through a 2G network.

8. The detecting device for display apparatus of claim 1, wherein
the reporting unit is used to report the comparison result from the comparison unit when the actual display content collected by the collecting unit is different from the test content.

9. A display system, comprising:
a display apparatus; and
a detecting device for display apparatus for detecting the display apparatus, wherein the detecting device for display apparatus comprises:
a control unit, for controlling the display apparatus to display a predetermined test content;
a collecting unit, for collecting an actual display content displayed on the display apparatus when the display apparatus is controlled to display the predetermined test content;
a comparison unit, for comparing the actual display content collected by the collecting unit with the test content to determine whether they are identical or not; and
a reporting unit, for reporting the comparison result from the comparison unit.

10. The display system of claim 9, wherein
the control unit controls the display apparatus to display the predetermined test content when the display apparatus is powered on.

11. The display system of claim 9, wherein
the test content includes monochrome pictures of primary colors of the display apparatus.

12. The display system of claim 11, wherein
the collecting unit is a color sensor.

13. The display system of claim 12, wherein
the color sensor is used to collect color at a corner of a display panel of the display apparatus.

14. The display system of claim 9, wherein
the reporting unit is a wireless transmitting unit for transmitting the comparison result from the comparison unit to a specified terminal wirelessly.

15. The display system of claim 14, wherein
the wireless transmitting unit is used to transmit the comparison result from the comparison unit to a specified terminal through a 2G network.

16. The display system of claim 9, wherein
the reporting unit is used to report the comparison result from the comparison unit when the actual display content collected by the collecting unit is different from the test content.

17. A detecting method of display apparatus, comprising:
a control unit controls the display apparatus to display a predetermined test content:
a collecting unit collects a actual display content displayed on the display apparatus when the display apparatus is controlled to display the predetermined test content;
a comparison unit compares the actual display content collected by the collecting unit with the test content to determine whether they are identical or not; and
a reporting unit reports the comparison result from the comparison unit.
